(19) United States
(12) Patent Application Publication
(10) Pub. No.: US 2012/0055563 A1
(43) Pub. Date: Mar. 8, 2012

(54) FOUNTAIN AUTOFILL VALVE KIT

(76) Inventor: Michael A. Stetson, Lake Elsinore, CA (US)

(21) Appl. No.: 12/874,718

(22) Filed: Sep. 2, 2010

(51) Int. Cl. F15D 1/00

(52) U.S. Cl. 137/41

(57) ABSTRACT

Provided is an easy-to-use and easy-to assemble automatic refill kit for maintaining a minimum water level within a fountain. The fountain refill kit is configured to connect with a conventional water source, such as a water hose, irrigation riser, or the like, to deliver water to the fountain's trough. The refill kit includes a float which moves as the water level within the fountain rises/falls. The float is connected to a valve arm which opens or closes the valve depending on the level of the water.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

This invention relates in general to a kit for automatically refilling the water in a fountain, and more specifically to a refill kit including a bracket and a float body disposable within the fountain to monitor the water level and to open a refill valve when the water drops below a preset refill level.

Fountains and other similar water features are well known in the art as architectural elements which emit water from an outlet for decorative or dramatic effect. Fountains may include varied surfaces or tiers of stone, metal, concrete, or the like, over which the water may flow from the water outlet to a reservoir or water collection trough.

The function of the fountain is typically dependent upon a sufficient amount of water being present in the reservoir. In particular, water is drawn from the reservoir and is pumped vertically upward to exit the fountain at the water outlet. The water falls downwardly from the water outlet back to the reservoir to complete a cycle. So long as there is a sufficient amount of water in the reservoir for water to be retrieved, the cycle generally continues.

However, operation of the fountain may cause the water level within the reservoir to decrease. For instance, as the water falls from the water output toward the reservoir, it may splash outside of the reservoir to the areas surrounding the fountain. Wind may also cause the water to exit the fountain as it falls from the water output toward the reservoir. In addition, the water levels may decrease over time as a result of evaporation.

As noted above, as the water level decreases below the water inlet of the pump, operation of the fountain may cease (i.e., the water cycle may be interrupted). Furthermore, if the pump continues to run, air may be pumped through the system which results in a dry pumping condition. The lack of water flowing through the system may cause the pump to overheat since heat from the pump is no longer being transferred to the water to cool the pump.

Such undesirable consequences may be avoidable if the water level of the fountain's reservoir is maintained above the pump intake. The water level may be maintained by manually tilling the reservoir as the water level recedes toward the pump intake. However. after manually filling the reservoir, the water level will more than likely recede back toward the pump intake, thereby requiring subsequent refilling which tends to be a very tedious and arduous endeavor. In this regard, the water level of the reservoir may be constantly monitored to ensure there is enough water within the reservoir for the fountain to operate. Such an endeavor may be more difficult if the water source is not in the immediate vicinity of the fountain.

In recognizing these deficiencies, various auto-fill systems have been developed for automatically filling a reservoir. The conventional auto-fill system is relatively expensive and includes copper tubing and timers and typically requires professional installation. As such, conventional auto-fill systems are used in larger applications, such as pools, hot-tubs, and the like.

In view of the foregoing, there is a need in the art for a fountain automatic-fill valve kit which may be disposed within a fountain and connected to a water source to constantly monitor the water level within the reservoir and open a refill valve to allow water to flow into the reservoir to maintain the water level within an operable range.

### BRIEF SUMMARY

The present disclosure relates to an easy-to-use and easy-to assemble automatic refill kit for maintaining a minimum water level within a fountain. The fountain refill kit is configured to connect with a conventional water source, such as a water hose, irrigation riser, or the like, to deliver water to the fountain's reservoir. The refill kit includes a float which moves as the water level within the fountain rises/falls. The float is connected to a valve arm which opens or closes the valve depending on the level of the water.

According to one embodiment, the fountain auto-fill valve kit includes a support bracket configured to be engageable with the fountain. A refill spout is connected to the support bracket and is disposable in fluid communication with the water supply to receive water from the water supply and to deliver water into the fountain. A valve is moveable relative to the refill spout between an open position and a closed position. The valve creates a fluid tight seal with the refill spout to restrict fluid flow through the refill spout when the valve is in the closed position. The valve is removed from fluid tight engagement with the refill spout as the valve moves from the closed position toward the open position. A float body is connected to the valve and defines a buoyant force to urge the float body to float on the water such that the float body moves relative to the fountain as the water level within the fountain changes. The valve is in operative communication with the float body such that the valve moves between the open position and the closed position as the float body moves relative to the fountain.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 depicts a side view of a auto-fill valve kit disposed within a fountain to maintain a minimum operable water level in the fountain;

FIG. 2 is an exploded upper perspective view of the auto-fill valve kit;

FIG. 3 is a side sectional view of the auto-fill valve kit with the valve being disposed in an open configuration;

FIG. 4 is a side sectional view of the auto-fill valve kit with the valve being disposed in a closed configuration;

FIG. 5 is a side sectional view of the auto-fill valve kit having a float body selectively attachable to a valve arm in a variety of orientations;

FIG. 6 is a second embodiment of the auto-fill valve kit having a bracket with a first portion and a second portion being offset by approximately 45 degrees;

FIG. 7 is an upper perspective view of an extension arm for use with the auto-fill valve kit; and

FIG. 8 is a side sectional view of the extension arm assembled between the valve arm and the float body.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Referring now to the drawings, wherein the showings are for purposes of illustrating a preferred embodiment of the present disclosure, and not for purposes of limiting the same, there is depicted an automatic refill valve kit 10 for maintaining the water level within a fountain 12. The valve kit 10 includes a refill valve 14 connected to a float body 16 and a conventional water source 18, such as a water hose or irrigation riser for providing water to the refill valve 14. The float body 16 moves relative to the refill valve 14 as the water level within the fountain 12 increases or decreases. As the water level approaches a minimum level, the valve opens to communicate water from the water source 18 into the fountain 12. When the water level approaches a maximum level, the refill valve 14 closes to prevent water from being communicated from the water source 18 to the fountain 12. The valve kit 10 may be configured to allow for easy assembly thereof (i.e., may not require professional installation).

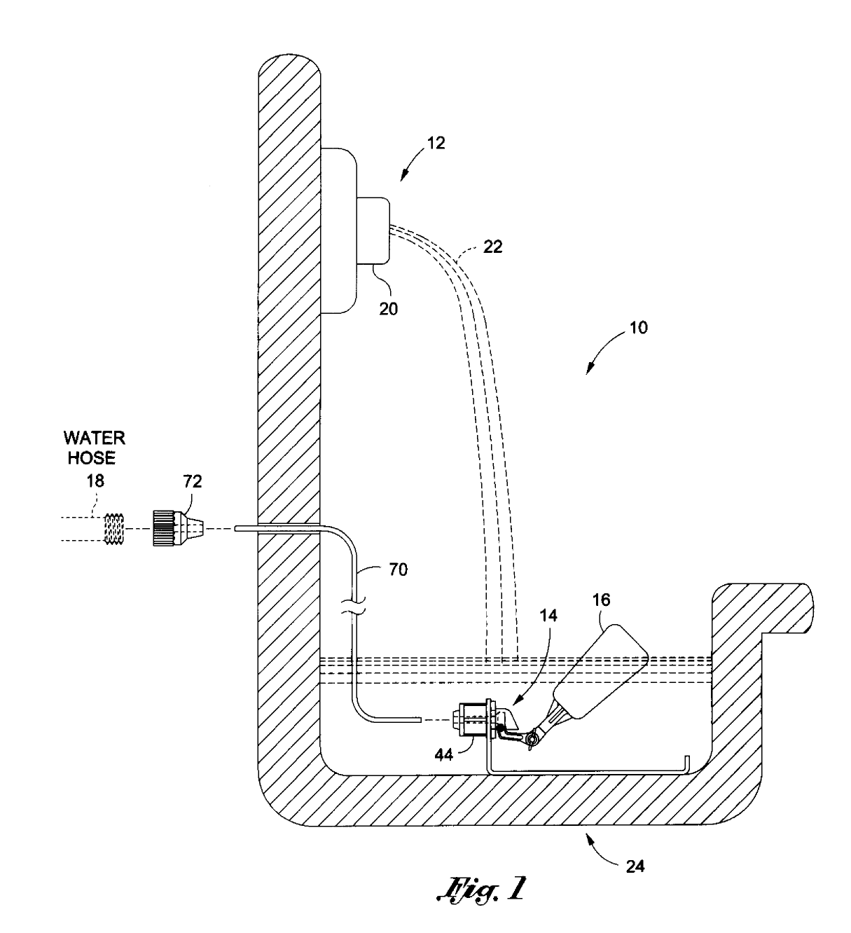

Referring now specifically to FIG. 1, the fountain 12 includes a water outlet 20 which emits water 22 into a fountain reservoir 24 or trough. The water 22 accumulates within the fountain reservoir 24 to define a water level. The water level fluctuates over time as a result of several factors, including but not limited to, the flow rate of the water outlet 20, the evaporation rate, wind, etc. The fountain 12 is configured to define a water cycle, where water is retrieved from the reservoir 24 and is pumped upwardly to the water outlet 20, where it is emitted to fall downwardly back into the fountain reservoir 24. In this regard, the fountain 12 repeatedly cycles the water 22 between the water outlet 20 and the fountain reservoir 24 when the fountain 12 is on (i.e., when the fountain 12 emits water 22 from the water outlet 20). In order to facilitate the aforementioned water cycle, the fountain 12 typically includes a water intake (not shown) in the fountain reservoir 24 to retrieve water from the fountain reservoir 24 before being pumped up to the water outlet 20. If the water level within the fountain reservoir 24 falls below the water intake, water may not be retrieved from the fountain reservoir 24, thereby interrupting the water cycle. An undesirable consequence of such interruption may be damage to the water pump which pumps the water from the fountain reservoir 24 to the water outlet 20. If the pump continues to run without water being retrieved from the fountain reservoir 24, the pump may overheat, requiring repair or replacement thereof. Therefore, it is desirable to maintain the water level above the water intake to ensure there is a sufficient amount of water in the fountain reservoir 24 to continue the water cycle. Various aspects of the valve kit 10 are intended to monitor level within the fountain reservoir 24, and to communicate water into the fountain reservoir 24 to maintain the water level at or above a minimum operating level (i.e., at a water level above the water intake).

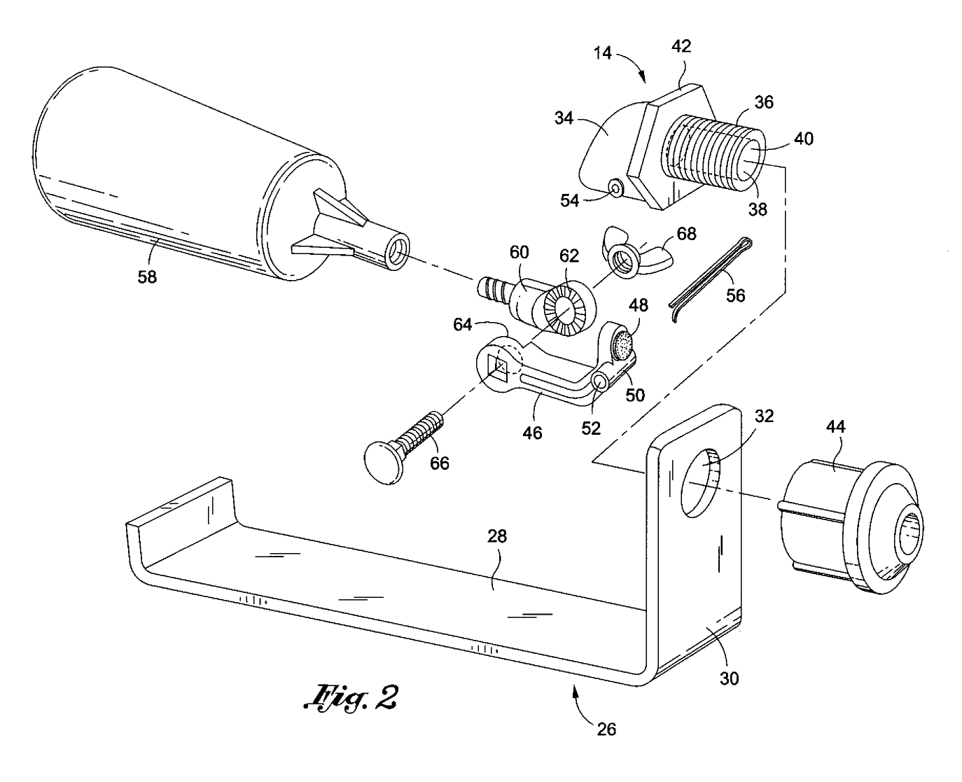

Referring now to FIGS. 1 and 2, the valve kit 10 includes a support bracket 26 having a first portion 28 and a second portion 30. The first portion 28 may be sized and configured to engage with or be mounted to the fountain 12. The second portion 30 is sized and configured to support the refill valve 14 and the various components associated therewith, as described in more detail below. In the particular embodiment depicted in FIG. 2, the first portion 28 resides within a first plane and the second portion 30 resides within a second plane which is substantially orthogonal to the first plane. The second portion 30 includes a bracket aperture 32 formed therein to accommodate engagement with the refill valve 14.

The refill valve 14 includes a refill spout 34, and a refill neck 36 extending from the refill spout 34. The refill neck 36 includes an inner wall 38 defining a fluid passageway 40 through the refill neck 36. A hexagonal abutment plate 42 is disposed at the juncture between the refill spout 34 and the refill neck 36 and extends radially outward from the refill neck 36. The refill neck 36 is advanced through the bracket aperture 32 until the abutment plate 42 is disposed in contact with the second portion 30 of the support bracket 26. A first connector 44 cooperatively engages with the refill neck 36 to secure the refill valve 14 to the support bracket 26. In the embodiment illustrated in FIG. 2, the refill neck 36 includes external threads which are configured to engage with internal threads (not shown) formed on the first connector 44.

A valve arm 46 is pivotably connected to the refill valve 14 and is moveable relative to the refill valve 14 between an open position, wherein fluid may flow through the fluid passageway 40, and a closed position to restrict fluid flow through the fluid passageway 40. The valve arm 46 includes a stopper member 48 and a pivot cylinder 50 defining a cylinder opening 52. The pivot cylinder 50 is sized and configured to be insertable within the refill spout 34 such that the cylinder opening 52 is coaxially aligned with a spout aperture 54 extending through the refill spout 34. A mechanical fastener such as a connector pin 56 may be advanced through the spout aperture 54 and the cylinder opening 52 to couple the valve arm 46 to the refill valve 14. The stopper member 48 is sized and configured to be positionable over the fluid passageway 40 when in the closed position to fluidly seal the fluid passageway 40. As the valve arm 46 pivots relative to the valve body from the closed position toward the open position, water may pass between the refill valve 14 and the stopper member 48.

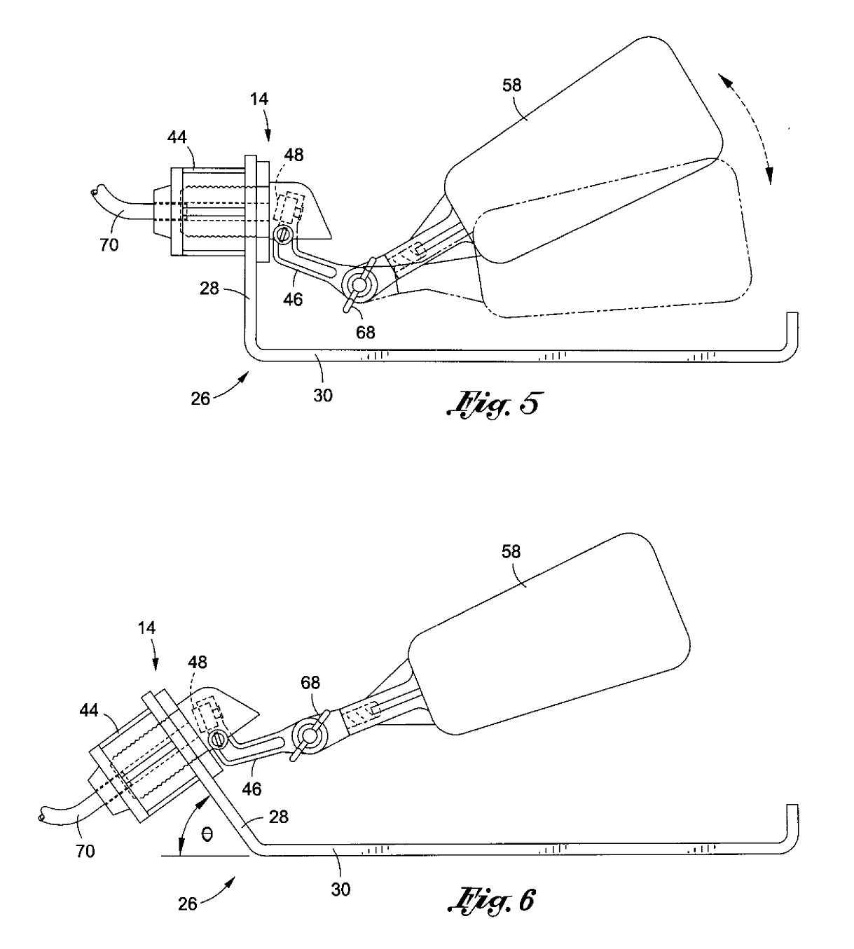

The valve arm 46 is connected to a float body 58 via a connecting element 60. As shown in FIG. 2, the float body 58 is threadably connectable to the connecting element 60. The connecting element 60 defines a first indexing face 62 that is cooperatively engageable with a second indexing face 64 formed on the valve arm 46. The first indexing face 62 may be indexed or rotated relative to the second indexing face 64 to alter the angular disposition of the connecting element 60 relative the valve arm 46. When the connecting element 60 is disposed in a preferred position relative to the valve arm 46, a connecting screw 66 is advanced through the first indexing face 62 and the second indexing face 64, and a wing nut 68 is screwed onto the connecting screw 66 to securely fasten and engage the first indexing face 62 to the second indexing face 64. In order to modify or alter the angular position of the connecting element 60, and ultimately the float body 58, relative to the refill valve 14, the wing nut 68 may be loosened to disengage the second indexing face 64 from the first indexing face 62 to allow for the desired alteration. Once the float body 58 is in the desired position, the wing nut 68 may be re-tightened to secure the first indexing face 62 to the second indexing face 64. FIG. 5 shows the float body 58 disposed in various positions relative to the valve arm 46.

Referring now back specifically to FIG. 1, the valve kit 10 further includes tubing 70 having a first end portion fluidly connectable to the first connector 44, and a second end portion fluidly connectable to a second connector 72. The second connector 72 is sized and configured to be fluidly engageable with the water source 18, whether it be a water hose, irrigation riser, or other water source known by those skilled in the art. The tubing 70 communicates the water from the second connector 72 to the first connector 44 and ultimately to the reservoir 24 via the refill valve 14. A hole may be drilled within the fountain to pass the tubing 70 therethrough.

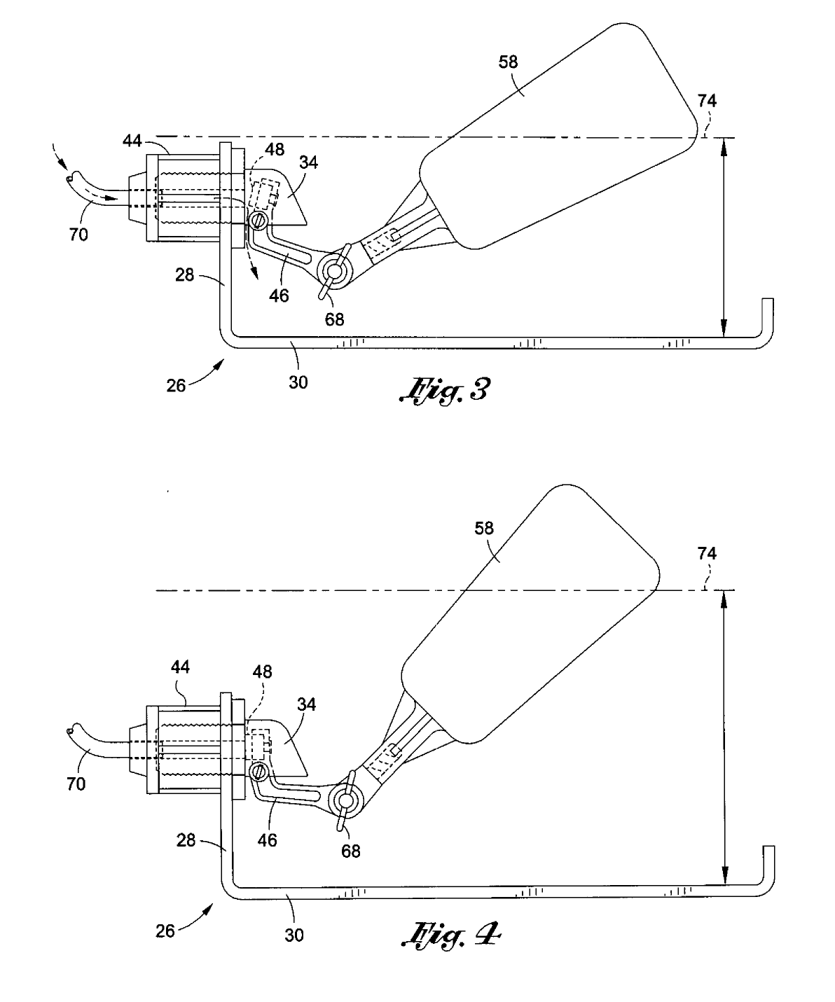

Referring now to FIGS. 3 and 4, the valve kit 10 is depicted in an assembled configuration, with the valve being disposed in an open position in FIG. 3, and a closed position in FIG. 4. More specifically, the water level 74 is shown in phantom and is at a level which has caused the float body 58 to move toward the second portion 30 of the support bracket 26 to disengage the stopper member 48 from the refill neck 36 to provide an opening through which water may pass therethrough. As the water level increases, the float body 58 moves away from the second portion 30 of the support bracket 26, thereby causing the valve arm 46 to pivot relative to the refill spout 34 to bring the stopper member 48 into engagement with the refill neck 36 to create a fluid type seal therebetween and to mitigate fluid communication from the tubing 70 into the reservoir 24.

Referring now to FIG. 6, there is depicted another embodiment of the refill kit 10 which includes a support bracket having a first portion 28 angularly disposed relative to the second portion 30 to facilitate mounting the support bracket 26 on a substantially vertical surface, i.e., a surface which is substantially orthogonal to the plane defined by the surface of the water. In this particular embodiment, the second portion 30 may be mounted to the vertical surface of the fountain 12, and the angular disposition of the first portion 28 may properly position the float body 58 at the surface of the water. In one particular embodiment, the angle fada defined between the first plane within which the first portion 28 resides, and the second plane within which the second portion 30 resides is approximately 45 degrees; however, it is understood that the angle fada may be varied without departing from the spirit and scope of the present disclosure.

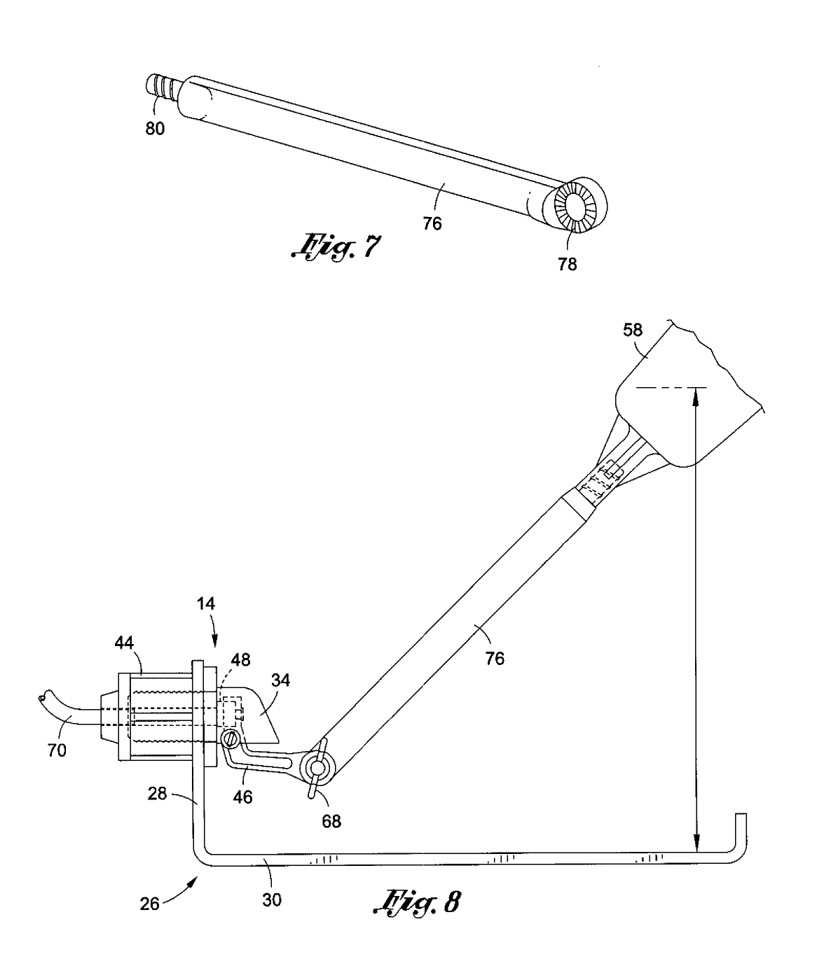

Referring now to FIGS. 7 and 8, it is contemplated that the valve kit 10 may include an extension arm 76 to accommodate fountains 12 having a deep reservoir 24. In other words, if the support bracket 26 is disposed at the bottom of the reservoir 24, and the float body 58 is disposed at the surface of the water, the extension arm 76 extends between the float body 58 and the valve arm 46 connected to the support bracket 26 to connect the float body 58 to the valve arm 46. The extension arm 76 defines an extension indexing face 78 which is engageable with the second indexing face 64 formed on the valve arm 46. The extension arm 76 additionally includes a float connector 80 disposed at an end portion opposite the extension indexing face 78. In this regard, the extension arm 76 essentially replaces the connecting element 60 to provide for greater distance between the float body 58 and the valve arm 46.

The above described components may be packaged and sold as the valve kit 10 and may be easily assembled at the site of the fountain 12. In this regard, one embodiment includes components which may be assembled without any tools. The components may also be fabricated from a material capable of withstanding continuous submersion within a fountain 12.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A fountain auto-fill valve kit for use with a water supply for automatically filling a fountain, the fountain auto-fill valve kit comprising:
a support bracket configured to be engageable with the fountain;
a refill spout connected to the support bracket, the refill spout being disposable in fluid communication with the water supply to receive water from the water supply and deliver water into the fountain;
a valve arm moveable relative to the refill spout between an open position and a closed position, the valve arm creating a fluid tight seal with the refill spout to restrict fluid flow through the refill spout when in the closed position, the valve arm being removed from fluid tight engagement with the refill spout as the valve arm moves from the closed position toward the open position; and
a float body connected to the valve arm, the float body defining a buoyant force to urge the float body to float on the water such that the float body moves relative to the fountain as the water level within the fountain changes, the valve arm moving between the open position and the closed position as the float body moves relative to the fountain.

2. The fountain auto-fill valve kit as recited in claim 1, further comprising an extension arm coupled to the valve arm and the float body.

3. The fountain auto-fill valve kit as recited in claim 1, further comprising a water tube disposed in fluid communication with the refill spout and fluidly connectable to the water supply to transfer water from the water supply to the refill spout.

4. The fountain auto-fill valve kit as recited in claim 1, wherein the support bracket includes a first bracket portion defining a first plane and a second bracket portion defining a second plane substantially orthogonal to the first plane.

5. The fountain auto-fill valve kit as recited in claim 1, wherein the support bracket includes a first bracket portion defining a first plane and a second bracket portion defining a second plane angularly offset from the first plane.

6. The fountain auto-fill valve kit as recited in claim 5, wherein the second plane is offset 45 degrees from the first plane.

7. The fountain auto-fill valve kit as recited in claim 1, wherein the valve arm is pivotally mounted to the refill spout.

8. The fountain auto-fill valve kit as recited in claim 1, wherein the float body is selectively adjustable relative to the valve arm.

9. A fountain auto-fill valve kit for use with a water supply for automatically filling a fountain, the fountain auto-fill valve kit comprising:
a refill spout being disposable in fluid communication with the water supply to receive water from the water supply and deliver water into the fountain;
a valve arm moveable relative to the refill spout between an open position and a closed position, the valve arm creating a fluid tight seal with the refill spout to restrict fluid flow through the refill spout when in the closed position, the valve arm being removed from fluid tight engagement with the refill spout as the valve arm moves from the closed position toward the open position; and
a float body connected to the valve arm, the float body defining a buoyant force to urge the float body to float on the water such that the float body moves relative to the fountain as the water level within the fountain changes, the valve arm moving between the open position and the closed position as the float body moves relative to the fountain.

10. The fountain auto-fill valve kit as recited in claim 9, further comprising an extension arm coupled to the valve arm and the float body.

11. The fountain auto-fill valve kit as recited in claim 9, further comprising a water tube disposed in fluid communication with the refill spout and fluidly connectable to the water supply to transfer water from the water supply to the refill spout.

12. The fountain auto-fill valve kit as recited in claim 9, wherein the valve arm is pivotally mounted to the refill spout.

13. The fountain auto-fill valve kit as recited in claim 9, wherein the float body is selectively adjustable relative to the valve arm.

14. A fountain refill kit for refilling a fountain with water from a water source to maintain a minimum water level within the fountain, the fountain refill kit comprising:
a float body configured to be disposable within the fountain to float on the water within the fountain;
a refill spout connectable to the fountain and fluidly connectable to the water source to receive water therefrom; and
a valve arm in operative communication with the float body, the valve arm being moveable relative to the refill spout between a closed position and an open position in response to movement of the float body as the water level within the fountain fluctuates.

15. The fountain refill kit as recited in claim 14, further comprising an extension arm coupled to the valve arm and the float body.

16. The fountain refill kit as recited in claim 14, further comprising a water tube disposed in fluid communication with the refill spout and fluidly connectable to the water supply to transfer water from the water supply to the refill spout.

17. The fountain refill kit as recited in claim 14, wherein the valve arm is pivotally mounted to the refill spout.

18. The fountain refill kit as recited in claim 14, wherein the float body is selectively adjustable relative to the valve arm.

19. The fountain refill kit as recited in claim 14, further comprising a support bracket connected to the refill spout and engageable with the fountain.

20. The fountain refill kit as recited in claim 19, wherein the support bracket includes a first bracket portion defining a first plane and a second bracket portion defining a second plane substantially orthogonal to the first plane.
